(19) United States
(12) Patent Application Publication
(10) Pub. No.: US 2004/0175545 A1
(43) Pub. Date: Sep. 9, 2004

(54) Laminate flooring planks incorporating antimicrobial agents

(76) Inventors: Robert R. Krebs, Georgetown, TX (US); Victoria Lynn Stolarski, Georgetown, TX (US); Curt R. Haffner, Temple, TX (US)

Correspondence Address: LISA M. SOLTIS, ILLINOIS TOOL WORKS INC., 3600 WEST LAKE AVENUE, GLENVIEW, IL, 60025, US

(21) Appl. No.: 10/773,859

(22) Filed: Feb. 6, 2004

Related U.S. Application Data
(60) Provisional application No. 60/447,712, filed on Feb. 19, 2003.

(51) Int. Cl. B32B 23/02

(52) U.S. Cl. 428/192

(57) ABSTRACT

A flooring plank includes a decorative upper surface, a core layer providing support and stability to the flooring plank and a backing layer secured to the underside of the core layer. The core layer includes a plurality of edges adapted for engagement with adjacent flooring planks during the installation of flooring planks in accordance with the present invention. In addition, the backing layer includes at least one sheet of resin impregnated paper and an antimicrobial agent acting upon unwanted biological organisms so as to inhibit the growth of mold, mildew, bacteria or other unwanted biological agents adjacent the underside of the flooring plank.

### CROSS REFERENCE TO RELATED APPLICATION

This application is based upon U.S. Provisional Patent Application Serial No. 60/447,712, filed Feb. 19, 2003, entitled “LAMINATE FLOORING PLANKS INCORPORATING ANTIMICROBIAL AGENTS”, which is currently pending.

### BACKGROUND OF THE INVENTION

1. Field of the Invention

The invention relates to laminate flooring. More particularly, the invention relates to laminate flooring planks and/or tiles impregnated with antimicrobial agents.

2. Description of the Prior Art

The laminate flooring industry is currently moving toward glueless systems for connecting adjacent flooring planks. For example, adjacent planks may rely upon interlocking edge profiles or connecting members selectively linking adjacent flooring planks. The implementation of these glueless systems removes the need for applying glue to adjacent planks so as to ensure the secure coupling of adjacent planks. As those skilled in the installation of laminate flooring systems are well aware, the removal of a gluing step in the installation process substantially increases the speed at which laminate flooring may be installed.

However, the removal of glue between adjacent flooring planks has led to new problems with regard to laminate flooring. For example, the use of glue imparted the additional function of providing a seal between adjacent flooring planks. The removal of glue from the installation process has rendered these glueless flooring systems susceptible to water damage when moisture leaks into the unsealed joints. To combat this problem, a sealant is applied to the edges of the glueless interlocking floors during the manufacturing process. The edge sealants are typically a wax, oil or curable coating (such as, a polyurethane).

Though the use of edge sealants has significantly improved the water resistance relating to the edge profiles of glueless laminate flooring systems, edge sealants do not fully fill the space between adjacent flooring planks. As such, there is still a concern that the exposed edges and backing layers of the laminate flooring planks will harbor dirt and dust, becoming a perfect medium upon which mold, mildew and bacteria will grow.

For example, it is very easy for a homeowner or storeowner to maintain the exterior surfacing of the flooring planks clean and free of mold, mildew and bacteria. The homeowner or storeowner need only clean the flooring surface in a manner commonly employed with all flooring surfaces. However, it is very difficult, if not impossible, for an individual to maintain the edges and backing layers clean and free of precursors to mold, mildew and bacteria. If, under the worst case circumstance, the unexposed edges and/or backing layer become infected with any of these harmful agents, it is virtually impossible to clean the flooring planks without completely removing the contaminated flooring planks.

Attempts have been made in the prior art to remedy this problem associated with the development of glueless flooring systems. For example, U.S. patent application Ser. No. 2002/0023702 to Kettler discloses a floorboard in which the edges of the floorboards are provided with an edge impregnation, serving to prevent moisture from penetrating into the board and inhibiting the infestation of pests along the edges of the floorboards. This is accomplished by mixing a pest control agent with an edge impregnation, and applying the mixture to the edge of a floorboard. While it is contemplated that the disclosed invention will be useful in addressing the formation of pests and various unwanted biological organisms, the floorboards disclosed by Kettler do not address the problems associated with the growth of mold, mildew, bacteria and other biological agents under the floorboards.

In addition, attempts have been made to produce decorative laminate offering antimicrobial, antibacterial and/or antifungal characteristics. For example, U.S. Pat. No. 6,248,342 to Trogolo et al. discloses an antimicrobial high-pressure laminate. However, Trogolo et al. fail to address the problems associated with the installation of high pressure laminate flooring planks, and the growth of undesirably biological agents beneath the exposed surface of flooring planks.

In addition to Trogolo et al. and Kettler, many patents disclose attempts to combat the development of undesirable biological agents in and around structural members. Attention is particularly directed to U.S. Pat. No. 1,711,884 to Gardner, U.S. Pat. No. 3,998,024 to Frandsen, U.S. Pat. No. 4,008,351 to Inoue et al., U.S. Pat. No. 4,128,688 to Wiley, U.S. Pat. No. 4,738,878 to Anderson et al., U.S. Pat. No. 5,270,108 to Savoy, U.S. Pat. No. 5,385,604 to Aislie, U.S. Pat. No. 5,494,947 to Kaplan, U.S. Pat. No. 5,553,431 to Pelosi, Jr. et al., U.S. Pat. No. 5,676,742 to Arendt et al., U.S. Pat. No. 5,783,258 to Garapick, U.S. Pat. No. 6,191,192 to Monden et al., and U.S. Pat. No. 6,332,293 to Kerr et al. While these patents disclose various attempts to address the problems associated with biological agents, none of these patents address the current problems associated with the growth of undesirable biological agents beneath the exposed surface of flooring planks.

As such, a need exists for a system, method and/or product for preventing the formation of mold, mildew, bacteria and other undesirable biological agents within the hidden spaces found among installed laminate flooring systems. The present invention provides a complete mechanism for inhibiting the growth of unwanted organisms by impregnating the backing layer with an antimicrobial agent and by adding an antimicrobial agent to the edge sealant before it is applied to the flooring planks in the manufacturing plant.

### SUMMARY OF THE INVENTION

It is, therefore, an object of the present invention to provide a flooring plank including a decorative upper surface, a core layer providing support and stability to the flooring plank and a backing layer secured to the underside of the core layer. The core layer includes a plurality of edges adapted for engagement with adjacent flooring planks during the installation of flooring planks in accordance with the present invention. In addition, the backing layer includes at least one sheet of resin impregnated paper and an antimicrobial agent acting upon unwanted biological organisms so as to inhibit the growth of mold, mildew, bacteria or other unwanted biological agents adjacent the underside of the flooring plank.

It is also an object of the present invention to provide a method for forming a flooring plank which inhibits the growth of unwanted organisms. The method is achieved by first forming a backing layer comprising at least one sheet of resin impregnated paper. The backing layer is formed so as to include an antimicrobial agent acting upon unwanted biological organisms. The backing layer is then secured to the underside of a core layer having a decorative surface along its upper surface. The backing layer ultimately inhibits the growth of mold, mildew, bacteria and other unwanted biological agents adjacent the underside of the flooring plank.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of a flooring plank in accordance with the present invention.

FIG. 2 is a cross sectional schematic of the flooring plank shown in FIG. 1.

FIG. 3 is a schematic of a system for coating opposite sides of a sheet with resins.

FIG. 4 is a schematic of a sheet coated in accordance with the system of FIG. 3.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

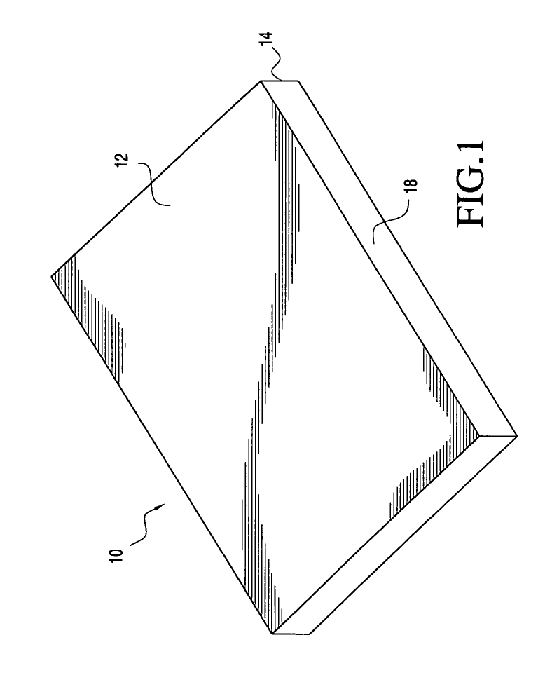

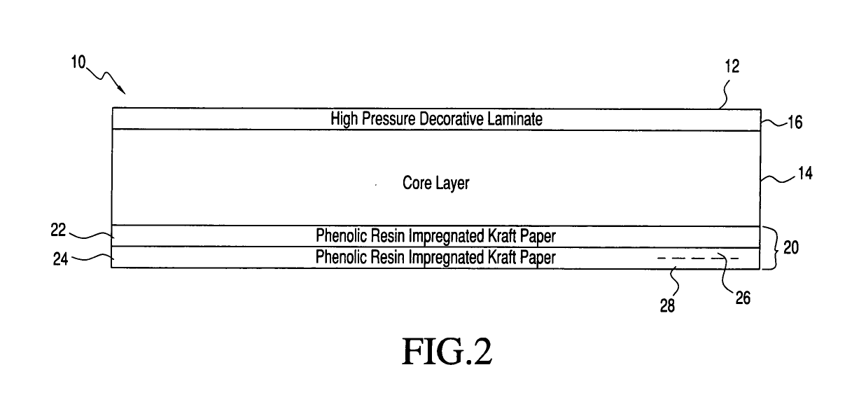

With reference to FIGS. 1 and 2, a flooring plank 10 in accordance with the present invention is disclosed. The flooring plank 10 includes a decorative upper surface 12 and a core layer 14 providing support and stability to the flooring plank 10. In accordance with a preferred embodiment of the present invention, the flooring plank 10 is a high pressure laminate flooring plank. As such, the flooring plank 10 includes a high pressure decorative laminate layer 16 secured to a core layer 14 made of medium density fiberboard or particle board. While specific materials for the core layer 14 and decorative laminate layer 16 are disclosed with reference to a preferred embodiment of the present invention, those skilled in the art will appreciate that the materials utilized may be widely varied without departing from the spirit of the present invention.

The core layer 14 is provided with a plurality of edges 18 shaped and dimensioned for engagement with adjacent flooring planks during the installation of flooring planks in accordance with known techniques employed within the flooring industry. As those skilled in the art will certainly appreciate, the teachings of the present invention may be applied to a wide variety of edge profiles without departing from the spirit of the present invention.

In addition to the core layer 14 and the decorative laminate layer 16, a backing layer 20 is secured to the underside of the core layer 14. The backing layer 20 is generally composed of resin impregnated paper with an antimicrobial agent incorporated therein. The antimicrobial agent acts upon unwanted biological organisms to inhibit the growth of mold, mildew, bacteria and/or other unwanted biological agents adjacent the underside of the flooring plank The term “antimicrobial agent” is utilized throughout the body of the present specification, and those skilled in the art should understand this term to generally describe compounds capable of combating harmful biological agents, including, but not limited to, bacteria, fungi, microbes, etc.

In particular, and in accordance with a preferred embodiment of the present invention, the backing layer 20 is composed of two sheets of resin impregnated kraft paper 22, 24. The first sheet 22, which is positioned adjacent the core layer 14 of the resulting plank 10, is composed of a phenolic resin impregnated kraft paper. As such, the first sheet 22 is preferably composed of phenolic resin impregnated kraft paper. In accordance with a preferred embodiment, the kraft paper is approximately 145-242 gram per square meter kraft paper impregnated with approximately 25-35 percent phenolic resin. The kraft paper is impregnated throughout and bonded with a substantially completely cured phenolic resin which has been converted to a thermoset state during the initial laminating step.

The second sheet 24, which is exposed to the external environment and ultimately rests upon the support surface on which the flooring plank 10 is positioned, is composed of kraft paper impregnated on one side 26 with phenolic resin and impregnated on the opposite side 28 with melamine, preferably melamine formaldehyde. In particular, the melamine impregnated side 28 of the second sheet 24 is exposed to the external environment so as to expose the antimicrobial agent incorporated therein to any undesirable biological agents coming into contact with the underside of the flooring plank 10. The process for preparing such a two sided resin impregnated sheet is disclosed in U.S. patent application Ser. No. 09/267,493 filed Mar. 12, 1999, entitled “System and Method For Two Sided Sheet Treating”, which issued as U.S. Pat. No. 6,610,358 and is incorporated herein by reference.

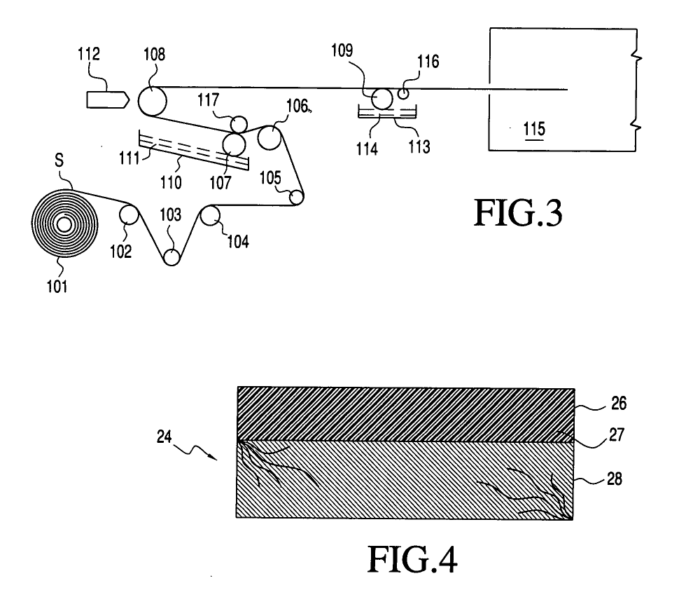

Briefly, and with references to FIGS. 3 and 4, the kraft paper is coated using as a system comprising a sheet of kraft paper S in the form of a roll 101, a series of rollers 102, 103, 104, 105, 106, 107, 108, 109, and 117, two pans 110, 113, metering devices 112, 116 and a curing device 115 such as may be an oven for applying a controlled amount of heat for subsequent curing of a coating substance. The pans 110, 113 contain phenolic resin 111 and melamine 114, respectively. The metering devices 112, 116 control the amount of phenolic resin 111 and melamine 114, respectively, remaining on the coated sheet S.

The sheet S is unwound and passed along the rollers 102, 103, 104, 105, 106, 107, 108, 109, and 117 to the curing device 115. Rollers 107 and 109 are coating rollers adapted to rotate within the pans 110, 113. Coating roller 107, which is adapted to be partly or totally submerged in the phenolic resin 111 contained in pan 110, is used to coat one side of the sheet S. Similarly, coating roller 109, which may be adapted to be partly or totally submerged in the melamine 114 contained in pan 113, is used to coat the other side of the sheet S. Rollers 102, 103, 104, 105 and 106 maintain a uniform tension on the surface of the sheet S and prevent it from slacking and/or tearing.

The phenolic resin 111 is fed into pan 110 and roller 107 is submerged in the phenolic resin 111 up to a desired level depending on the amount of the phenolic resin 111 needed to coat one side of the sheet S. Thus, when coating roller 107 rotates in pan 110, the surface of roller 107 is coated with the phenolic resin 111 and when the first surface of the sheet S comes in contact with roller 107, roller 107 coats the first surface of the sheet S with the desired amount of the phenolic resin

In accordance with a preferred embodiment of the present invention, the sheet S passes around roller 108 which is positioned after roller 107 and changes the orientation of the sheet S such that the second side of the sheet S touches coating roller 109. According to a preferred embodiment of the present coating system, the sheet S is made to pass over coating roller 109 such that the second surface of the sheet S touches coating roller 109. Coating roller 109 is located such that, if desired, it may be submerged partially or totally in melamine 114 contained in pan 113. The melamine 114 is fed into pan 113 and the surface of roller 109 is coated with a desired amount of the melamine 114. Thus, when the second surface of the sheet S comes in contact with roller 109, roller 109 coats the second surface of the sheet S with melamine.

In accordance with a preferred embodiment of the present invention, and in an effort to impart antimicrobial characteristics to the present flooring plank, an antimicrobial agent is incorporated into the melamine applied to the second surface of the sheet S. As discussed below in substantial detail, a water-based iodinated sulfone, for example, ULTRA-FRESH 15, as manufactured by Thomson Research, is mixed with the melamine for application therewith. While a water-based iodinated sulfone is utilized as an antimicrobial agent in accordance with a preferred embodiment of the present invention, other antimicrobial agents compatible with the water-based melamine system, such as organochlorides, quaternary ammonium compounds, etc., may be used without departing from the spirit of the present invention. Specifically, ULTRA-FRESH 15 is added to melamine formaldehyde resin at 0.05 to 1.0% by weight of resin. Most preferably, the ULTRA-FRESH 15 is added at 0.3 to 0.5% by weight of resin.

The melamine may be fortified further, if desired, with other substances which improve the properties of the melamine resin or improve the treatability of the kraft paper sheets. For example, glycols, sugars, and/or cyclic amids can be added to the melamine to provide increased flow, gloss and/or flexibility respectively of the resin. Once the sides of the sheet S are respectively coated with phenolic resin and melamine, the sheet S is subjected to a B-staging process, or other conditioning step, to preferably cure the phenolic resin 111 and melamine 114. For this purpose, the sheet S is preferably passed through a curing device 115. The environment inside the curing device 115 may be controlled such that, if desired, different temperatures, pressures, catalysts, or the like may be maintained on opposite sides of the sheet S or at different points within the curing device 115 to facilitate efficient curing of the phenolic resin 111 and melamine 114.

FIG. 4 shows a schematic of a sheet 24 coated in accordance with the method described above. The phenolic resin 26 is coated on one side of the sheet 24 as shown so that a portion of the phenolic resin 26 remains on the surface of the sheet 24 and another portion of phenolic resin penetrates the sheet 24 up to a desired level 27. The sheet 24 is coated on an opposing surface with melamine 28 which penetrates the sheet 24 up to a desired level 27 as shown.

Returning to FIG. 2, once the two sheets 22, 24 of the backing layer 20 are prepared, they are layered in a conventional manner and consolidated under heat and pressure to form a high pressure laminate sheet. Specifically, high pressure laminates are generally manufactured by placing the resin impregnated core and decorative sheet between steel plates and subjecting the laminate stack to temperatures in the range of approximately 110° C. to 155° C. and pressures in the range of about 56.24 kg/cm² to 112.48 kg/cm² for a time sufficient to consolidate the laminate and cure the resins (generally about 25 minutes to an hour). The pressure and heat force the resin in the paper sheets to flow, cure and consolidate the sheets into a unitary laminated mass referred to in the art as a high pressure laminate.

While two sheets of resin impregnated kraft paper are used in accordance with a preferred embodiment of the present invention, those skilled in the art will appreciate other layering structures which could be employed without departing from the spirit of the present invention. In addition, those skilled in the art will also appreciate the variations in the composition of the backing layer which may be employed without departing from the spirit of the present invention.

Once the decorative laminate layer 16 and the backing layer 20 are prepared, the flooring plank 10 is assembled. Specifically, the high pressure decorative laminate layer 16 is adhesively bound to the core layer 14 with the decorative surface 12 of the decorative laminate layer 16 exposed. The backing layer 20 is also adhesively secured to the core layer 14. The backing layer 20 is secured to the core layer 14 such that the melamine/antimicrobial side 28 of the second sheet 24 is exposed and the first sheet 22 is directly secured to the core layer 14.

In addition to the incorporation of antimicrobial agents in the backing layer 20 of the flooring planks 10 in accordance with the present invention, it is contemplated that the edge profiles 18 may also be treated with an antimicrobial agent so as to provide optimum protection to the flooring planks and the surrounding area. By treating the edge profiles 18 of the flooring planks as described below, not only is the development of undesirable biological agents along the flooring plank edges 18 controlled, the passage of undesirable biological agents to and from the space under the flooring plank 10 is controlled.

In accordance with a preferred embodiment of the present invention, the edges 18 of the flooring planks 10 are treated with an antimicrobial agent by incorporating the same in an edge sealant currently being utilized in the fabrication of flooring planks. In accordance with a preferred embodiment of the present invention, the edge sealant is ENERSEAL 17, sold by BP Schmierstoff GmbH. As discussed above, current edge sealants are designed to prevent the penetration of moisture into the edge profiles of adjacent flooring planks. The edge sealants replace some of the functionalities provided by the adhesives utilized in prior glue-locking flooring systems. As those skilled in the art will certainly appreciate, the edge sealants utilized in accordance with this portion of the treatment process may take a variety of forms. For example, and in accordance with a preferred embodiment of the present invention, a wax/oil emulsion may be applied to the flooring edges to provide moisture resistance. It is also contemplated that other moisture resistant sealants, such as polyurethanes, epoxides, etc, may be used while remaining within the spirit of the present invention.

It is further contemplated that the edge sealant may be replaced with a water-based, dry adhesive; that is, a pre-applied adhesive which is coated along the locking edges of laminate flooring planks and only activated upon engagement of adjacent flooring planks. In accordance with the present invention, the flooring planks are cut with a tongue/groove profile allowing for mechanical glueless locking and the “dry adhesive” is pre-applied so as to improve the locking system's yield seam strength. Such “dry adhesive” may be composed of PVA (polyvinyl acetate) or PBA (polybutyl acrylate). As with the edge sealant, an antimicrobial agent is combined with the “dry adhesive” prior to application such that the benefits of the antimicrobial agent are incorporated with the “dry adhesive”.

In accordance with the use of either PVA or PBA, the “dry adhesive” is pre-applied to opposite edges of the flooring planks. When the edges are connected as the floor is assembled, the adhesive “flows”, activating the bonding of the opposed edges of the flooring planks.

As for the antimicrobial agent added to the edge sealant or adhesive, TRICLOSAN, a chlorophenol, more particularly, a chlorophenol ether, manufactured by Ciba Chemical Inc., is utilized in accordance with a preferred embodiment of the present invention. However, other antimicrobial agents, for example, ULTRA-FRESH DM 50, an organotin, quatinary ammonium salt (tri-n-butyltin maleate), manufactured by Thomson Research Associates, or IRGAGUARD B1000, another TRICLOSAN-based product, manufactured by Ciba Specialty Chemical, may be utilized within the spirit of the present invention.

In accordance with preferred embodiments of the present invention, the antimicrobial agent is added to the edge sealant at the rate of between approximately 0.1% to approximately 0.75% by weight. In practice, the edge sealant is applied to the edge profiles of the flooring planks at a coating thickness of approximately 1.6 g/sq. ft., and the antimicrobial agent should be incorporated in the edge sealant at compositions which are sufficient to provide effective protection at this application level. Loading rates for the adhesive will similarly be adjusted to provide an effective antimicrobial level based upon the amount of adhesive applied to the edges of the flooring planks. Those skilled in the art will appreciate the strength of various edge sealants (or adhesives) and antimicrobial agents which may be utilized in accordance with the present invention, and further appreciate possible variations within the disclosed embodiment which may be employed without departing from the spirit of the present invention.

The use of antimicrobial agents at specific locations within a decorative laminate flooring plank substantially reduces the potential development of undesirable biological agents adjacent the unexposed, and inaccessible, sections of the flooring plank In fact, the application of antimicrobial agents within the backing layer of flooring planks provides a large surface area for combating the undesirable biological agents in the vicinity of the flooring planks. Similarly, the application of antimicrobial agents to edges of flooring planks enhances the effectiveness of the treated backing layer by combating undesirable biological agents as they attempt to move between the upper surface of the flooring plank and an unexposed position beneath and around the flooring planks.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A flooring plank comprising:
a decorative upper surface;
a core layer providing support and stability to the flooring plank, the core layer including a plurality of edges adapted for engagement with adjacent flooring planks during the installation of flooring planks;
a backing layer secured to an underside of the core layer, the backing layer comprising at least one sheet of resin impregnated paper and an antimicrobial agent acting upon unwanted biological organisms so as to inhibit the growth of mold, mildew, bacteria or other unwanted biological agents adjacent an underside of the flooring plank

2. The flooring plank according to claim 1, wherein the decorative upper surface is high pressure decorative laminate.

3. The flooring plank according to claim 1, wherein the core layer is medium density fiberboard or particle board.

4. The flooring plank according to claim 1, wherein the edges of the core layer are treated with a sealant containing an antimicrobial agent

5. The flooring plank according to claim 4, wherein the antimicrobial agent applied to the edges of the core layer is a chlorophenol.

6. The flooring plank according to claim 1, wherein the antimicrobial agent applied to the backing layer is a water-based iodinated sulfone.

7. The flooring plank according to claim 1, wherein the backing layer is composed of a first sheet and a second sheet of resin impregnated kraft paper consolidated under heat and pressure to form a laminate.

8. The flooring plank according to claim 7, wherein the first sheet is a phenolic resin impregnated kraft paper and the second sheet is impregnated with both melamine and phenolic resin, the second sheet including a first surface coated with the phenolic resin and a second surface coated with the melamine such that the second surface is exposed when the backing layer is secured to the core layer.

9. The flooring plank according to claim 8, wherein the antimicrobial agent is incorporated in the melamine applied to the second surface of the second sheet of the backing layer.

10. The flooring plank according to claim 9, wherein the antimicrobial agent is a water-based iodinated sulfone

11. A method for forming a flooring plank which inhibits the growth of unwanted organisms, comprising the following steps:
forming a backing layer comprising at least one sheet of resin impregnated paper, the backing layer being formed so as to include an antimicrobial agent acting upon unwanted biological organisms;
securing the backing layer to an underside of a core layer having a decorative surface along its upper surface, the backing layer being secured to the underside of the core layer so as to inhibit the growth of mold, mildew, bacteria and other unwanted biological agents adjacent an underside of the flooring plank.

12. The method according to claim 11, further including the step of securing a decorative layer of high pressure decorative laminate to a side of the core layer opposite the backing layer.

13. The method according to claim 11, wherein the core layer is medium density fiberboard or particle board.

14. The method according to claim 11, further including the step of treating edges of the core layer with a sealant containing an antimicrobial agent.

15. The method according to claim 14, wherein the antimicrobial agent applied to the edges of the core layer is a chlorophenol.

16. The method according to claim 11, wherein the antimicrobial agent is a water-based iodinated sulfone.

17. The method according to claim 11, wherein the backing layer is composed of a first sheet and a second sheet of resin impregnated kraft paper consolidated under heat and pressure to form a laminate.

18. The method according to claim 17, wherein the first sheet is a phenolic resin impregnated kraft paper and the second sheet is impregnated with both melamine and phenolic resin, the second sheet including a first surface coated with the phenolic resin and a second surface coated with the melamine such that the second surface is exposed when the backing layer is secured to the core layer.

19. The method according to claim 18, wherein the antimicrobial agent is incorporated in the melamine applied to the second surface of the second sheet of the backing layer.

20. The method according to claim 19, wherein the antimicrobial agent is a water-based iodinated sulfone
